(19) United States
(12) Patent Application Publication
(10) Pub. No.: US 2008/0131547 A1
(43) Pub. Date: Jun. 5, 2008

(54) External Sprue Bar Position Alignment Apparatus

(75) Inventors: Sohail Mohammed, Colchester, VT (US); Patrice Fabien Gaillard, Milton, VT (US); Edward Joseph Jenko, Essex, VT (US); Sean Ian Weir, Toronto (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: Husky Injection Molding Systems Ltd., Bolton (CA)

(21) Appl. No.: 11/565,412

(22) Filed: Nov. 30, 2006

(51) Int. Cl. B29C 45/17; B29C 45/03; B29C 45/27

(52) U.S. Cl. 425/168; 425/567; 425/574

(57) ABSTRACT

An external sprue bar position alignment device is comprised of a mounting bracket and a sprue bar alignment frame that is attached to the mounting bracket. The sprue bar alignment frame and mounting bracket define a channel configured to receive a sprue bar upon a mold closing. The sprue bar alignment frame and the mounting bracket are disposed to maintain alignment of an end of the sprue bar with an injection nozzle. The device includes an adjustment device, said adjustment device provided for movement of at least one of the mounting bracket or the sprue bar position alignment frame relative to a path of the sprue bar such that at least one of the mounting block or the sprue bar position alignment frame may bias the sprue bar in a selected direction upon the molding closing. The sprue bar position alignment device may be adjusted without disassembling the mold.

### TECHNICAL FIELD OF THE INVENTION

The field of the present invention is in plastic injection molding machines.

### DESCRIPTION OF THE RELATED ART

Sprue Bars are generally known in the prior art and are used to convey molten plastic from the nozzle of the injection machine to the hot runners that feed a plurality of mold cavities for making plastic parts. A mold typically comprises two mold plates: a core plate and a cavity plate. The mold cavity and core plates are brought together into a closed position for injection of molten plastic and then separated into an opened position for removal of the finished part. Opening and closing the mold plates is achieved between two platens, one of which is typically stationary and the other of which is typically moved by mechanical, electrical or hydraulic actuators.

When the mold is closed, a sprue bar must engage either the mold cavity itself or more typically the hot runner which is used in many molds to distribute the molten plastic to the mold cavities. At its opposing end, the sprue bar must engage the nozzle of the injection machine. The injection machine introduces molten plastic into the channel of the sprue bar, under enough pressure to force the plastic into the mold cavities. Both ends of the sprue bar must adequately seal with their corresponding components in order to prevent leakage of the molten plastic. Even in the simplest configurations, the sprue bar is maintained in channels provided for it through other parts, including at least a platen and a mold plate.

Stack molds are frequently used in order to reduce production time. Stack molds include multiple molds so that multiple parts may be made in each injection cycle. In many configurations the stack is arranged along the axis the mold plates travel when the mold opens and closes. In such configurations some sprue bars may be maintained in and travel through channels provided for them in more than two other mold components. In some stack molds, sprue bars must extend through not only a stationary platen and a mold plate for the mold they serve, but also through the mold plates of a different mold in the stack. Examples of stack molds may be found in U.S. Pat. Nos. 5,522,720 and 5,578,333.

The proper alignment of the ends of the sprue bars with the injection nozzles is critical. Because sprue bars can extend outside the mold by half their length or more, their ability to align precisely with the injection unit nozzle may be adversely affected by only small variances in the mold. Molten plastic flashing or “drool” may cause the movement of one or more sprue bars out of its ideal alignment. Misalignment may become problematic by causing the sprue bar to lose its proper seal with its injection nozzle. Through repeated cycles of use, misaligned sprue bars may also cause undesirable early or accelerated wear or deformation of injection nozzles or the sprue bars themselves, necessitating replacement expense and interruptions in production.

Certain guide bushings or sleeves for alignment and guiding may be found in the prior art. For example, in U.S. Pat. No. 5,910,327 to Schad and assigned to Husky Injection Molding Systems Ltd., sleeves and guide bushings are used within the confines of the mold frame. A problem with maintaining proper sprue bar alignment position with such guide bushings or sleeves is that these components are internal to the molds. Accordingly, any adjustments to the sprue bar alignment components to compensate for misalignment requires a halt in production and a certain amount of disassembly of the mold components in order to reach and then properly adjust guide elements. Accordingly, it would be advantageous to have an alignment position mechanism external to the mold itself, that is, a device that does not require any disassembly of the mold to adjust.

Moreover, molders are reluctant to accept non-external modifications to their molding machines for the purpose of providing better sprue bar alignment because it is costly, time consuming and since they may have many machines which need to run the same mold. Each machine would need to be individually tailored to precisely interact with each mold having sprue bars, to achieve mold-machine flexibility. Furthermore, since molds having sprue bars may be configured with a different number and size of sprue bars, dedicated alignment devices for each mold would become unmanageable.

Other prior art alignment devices have been disclosed, as for example the alignment device of U.S. Pat. No. 6,241,507 V1 to Kuo which discloses a device for initial alignment of an injection nozzle and sprue bar. Disadvantageously, it does not provide for any maintenance of proper alignment through production cycles.

There is a need in the art for a sprue bar position alignment device and for such a device that may be adjusted externally to the moving mold components. There is a continuing need for durability and economy in construction and operation of these components.

### SUMMARY OF THE INVENTION

An external sprue bar position alignment device is comprised of a mounting bracket and a sprue bar alignment frame that is attached to the mounting bracket. The sprue bar alignment frame and mounting bracket define a channel configured to receive a sprue bar upon a mold closing. The sprue bar alignment frame and the mounting bracket are disposed to maintain alignment of an end of the sprue bar with an injection nozzle. The device includes an adjustment device, said adjustment device providing movement of at least one of the mounting bracket or the sprue bar position alignment frame relative to a path of the sprue bar such that at least one of the mounting block or the sprue bar alignment frame may bias the sprue bar in a selected direction upon the molding closing.

In one embodiment, the adjustable sprue bar position alignment device is operatively mounted between a mold platen face and an injection unit. One or more sprue bars may be received in the apertures of the sprue bar frame(s) in the device. The sprue bar position alignment device provides support for the sprue bars and aligns the sprue bars with the injection unit. In one embodiment, the sprue bar position alignment device is adjustable such that the sprue bar(s) may be moved in both the X and Y directions. An adjustable frame mechanism may be removable to accommodate multiple and/or various sprue bar configuration(s). Replaceable wear pads to decrease wear on the sprue bar are disposed within the aperture of the frame.

The device is adjustable to account for any misalignment as a result of sprue bar sagging or worn guide pads. The guide mechanism and wear components are serviceable without having to remove mold plates. The sprue bar position alignment device may be mounted using fasteners in existing tapped holes in order to retrofit existing molds without additional manufacturing. The framework is readily installed on a variety of machine platen configurations, using existing mounting locations in many cases.

The device may advantageously maintain an alignment of the sprue bar from a position between the mold and the injection unit, allowing for better durability and wear life of components.

The sprue bar position alignment device is adjustable for precision alignment with any injection unit nozzle. Adjustments may be made externally to the mold, that is, without disassembling the mold components.

It provides a framework for readily attaching a multitude of adjustable alignment fixtures, designed specifically for a particular sprue bar configuration.

The sprue bars slide on wear pads held in place by the position alignment frames. The sprue bar may also disengage the alignment device during mold opening. As the mold closes the sprue bar(s) engage and slide on the wear pad until the sprue bar engages the injection unit nozzle. The pads can be re-adjusted to account for their wear or minor changes in position of the mold frame or injection unit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a schematic view that depicts the injection molding stack in an open position;

FIG. 1B depicts the injection molding stack in a partially closed position;

FIG. 1C depicts the injection molding stack in another partially closed position;

FIG. 1D depicts the injection molding stack in a closed position;

FIG. 2 is an isometric view of the external sprue bar position alignment device of the present invention;

FIG. 3 is a plan view of the external sprue bar position alignment device;

FIG. 4 is a cut away side view of the external sprue bar position alignment device showing the channels defined by the device;

FIG. 5 is a cut away side view of the external sprue bar position alignment device showing the attachment of the sprue bar alignment frames to the mounting bracket;

FIG. 6 is a side view of the external sprue bar position alignment device;

FIG. 7a is an isometric view of a stationary platen with the sprue bar position alignment device in place; and

FIG. 7b is a close up of a stationary platen with the sprue bar position alignment device in place.

### DETAILED DESCRIPTION OF THE PREFERRED EMBODIMENTS

The following description of the preferred embodiment(s) is merely exemplary in nature and is in no way intended to limit the invention, its application, or uses.

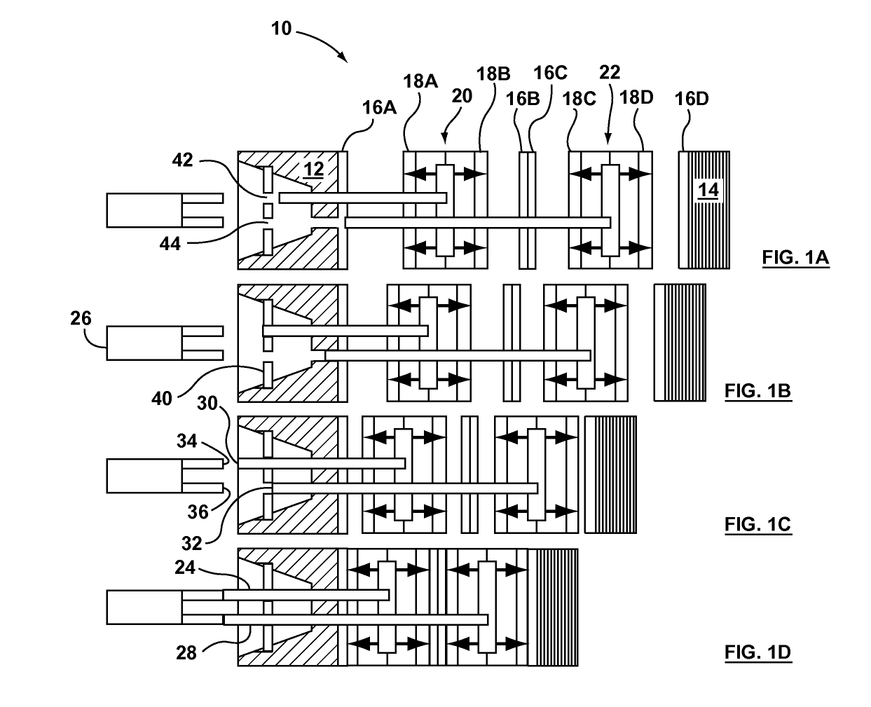

Referring now to the drawings wherein like reference numbers refer to like elements, FIGS. 1A, 1B, 1C and 1D schematically show the relative positions of sprue bars 24, 28 to other mold components, including the position of the external sprue bar position alignment device 40 of the present invention, at various times in the production cycle.

A stack mold 10 is positioned between a stationary platen 12 and a moving platen 14 of an injection molding machine 26. The moving platen 14 is typically moved by a mechanical, electric or hydraulic ram (not shown). Between the platens 12, 14 of the depicted embodiment are four sets of core and cavity plates 16A, 18A; 18B, 16B; 16C, 18C; 18D, 16D (shown from left to right), wherein each pair of plates mate with one another to define a hollow cavity corresponding to the shape of the plastic part being made and into which the molten plastic is injected. Hence, there are four core plates 16A, 16B, 16C, 16D and four cavity plates 18A, 18B, 18C, 18D, which are arranged in pairs as previously specified from left to right. These core and cavity plates 16A, 18A; 18B, 16B; 16C, 18C; 18D, 16D are fed molten plastic via hot runner plates 20 and 22. Hot runner plates are generally known in the industry. The hot runner plates 20, 22 have flow channels that carry molten plastic received from the sprue bars 24, 28, respectively, and distribute the molten plastic to the mold cavities at a plurality of preconfigured gates. In the depicted four level stack mold, the first hot runner plate 20 delivers molten plastic received from the first sprue bar 24 to the first core/cavity plate pair 16A, 18A located to the left of the hot runner assembly 20 and to the second cavity/core pair 18B, 16B located to the right of hot runner assembly 20 as is shown in FIG. 1. The second hot runner plate assembly 22 delivers molten plastic received from the second sprue bar 28 to the third core/cavity plate pair 16C, 18C located to the left of hot runner assembly 22 and to the fourth cavity/core plate pair 18D, 16D located to the right of the hot runner assembly 22 as is shown in FIG. 1.

Each of the sprue bars 24, 28 has a first end 30, 32 that must mate and adequately seal with a first injection machine nozzle 34 and a second injection machine nozzle 36, respectively, which delivers the molten plastic to the sprue bars 24, 28 under pressure from the injection machine 26, after the stack mold 10 is fully closed. The closure of the stack mold 10 typically takes a fraction of a second. The entire molding cycle may take several seconds.

FIGS. 1A through 1D show the stack mold 10 progressively closing. As can be seen from these figures, the core/cavity plate pairs 16A, 18A; 18B, 16B; 16C, 18C; 18D, 16D and the hot runner plate assemblies 20, 22 all move relative to one another as the stack mold 10 closes. As can be seen by comparing FIGS. 1A, 1B, 1C and 1D, the sprue bars 24, 28 also move relative to each other, relative to the stationary platen 12 and relative to the injection machine nozzles 34, 36 as the stack mold 10 closes. As can be further seen, the first sprue bar 24 and second sprue bar 28 must move through channels made for them in multiple components including the core/cavity plates 16A, 18A; 18B, 16B; 16C, 18C, the hot runner plates 20, 22 and the stationary platen 12. Upon full closure, each of the sprue bars 24, 28 extends outside the stack mold 10 envelope for significant portions of the sprue bars' 24, 28 lengths.

The external sprue bar position alignment device 40 of the present invention is depicted in its mounting on the stationary platen 12. As schematically depicted, a first channel 42 and a second channel 44 are defined by components of the external sprue bar position alignment device 40 and act to maintain each of the sprue bars 24, 28 along a desired path that advantageously brings the first ends 30 and 32 of each of the sprue bars 24, 26 into adequate sealing contact with the machine nozzles 34 and 36, respectively. In alternative embodiments, the number of channels may be one or more depending on the number of sprue bars used. Therefore, it is envisioned that the external sprue bar position alignment device 40 may be used with one or more sprue bars.

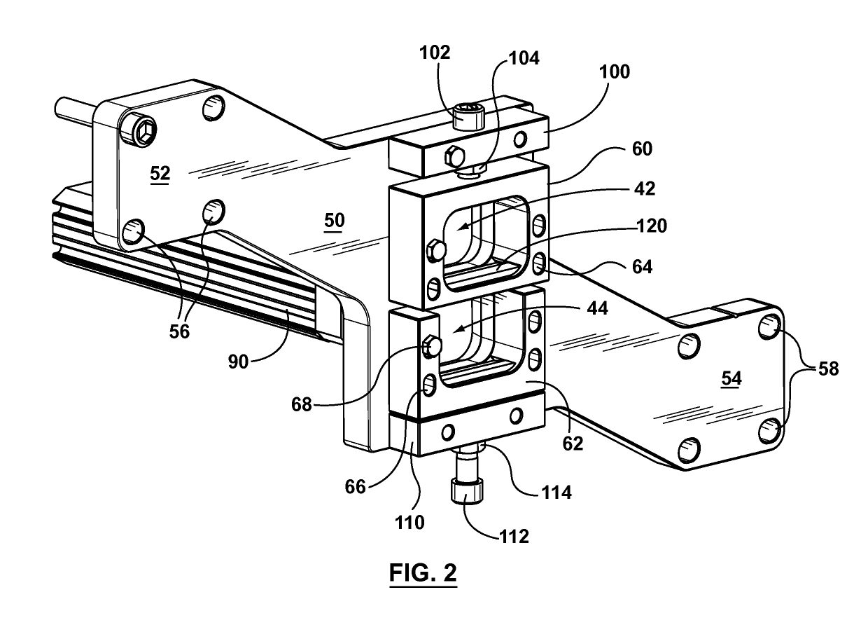

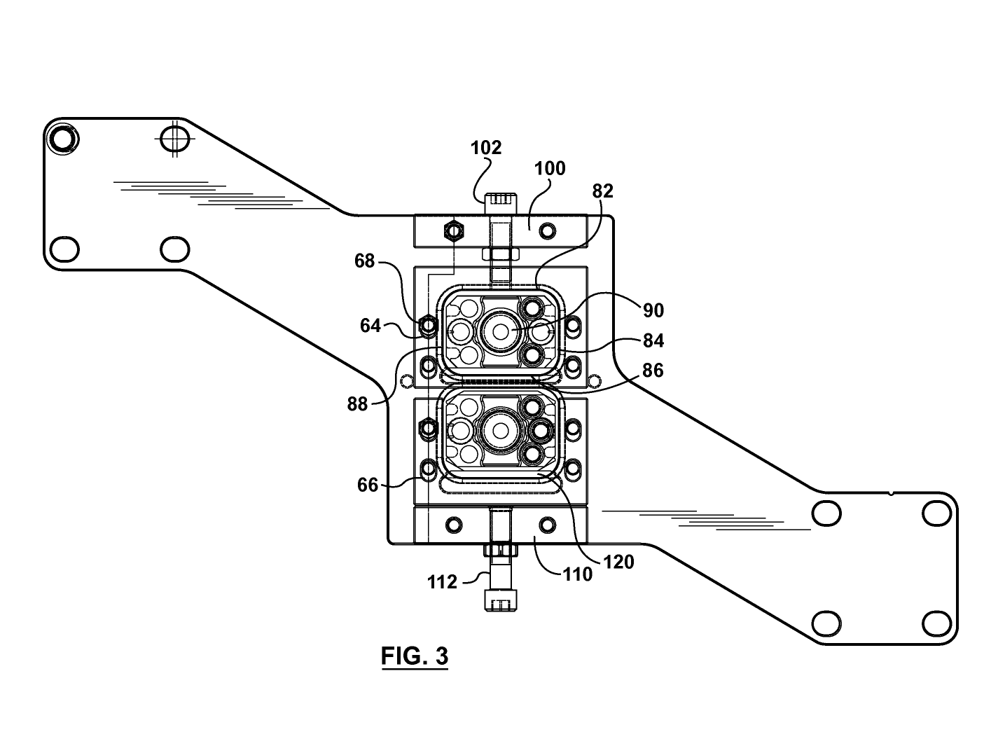

As can be seen in FIGS. 2 and 3, the external sprue bar position alignment device 40 includes a mounting bracket 50. In the depicted embodiment, the mounting bracket 50 has a first extension 52 and a second extension 54, each of which has one or more through holes for bolts used to mount the mounting bracket 50. As also shown in the depicted embodiment, the mounting holes 56, 58 are slotted along at least one axis. In the depicted embodiment, it is bolted to the stationary platen 12. The slotted bolt holes allow the mounting bracket 50 to float with respect to the slotted platen 12 before tightening and be installed with the requisite degree of precision to properly align the sprue bars 24, 28. Thereafter, the slotted through holes provide for the mounting bracket 50 to be used as one type of adjustment device. In operation, the paths of the sprue bars 24, 28 traveling through channels 42 and 44, respectively, may be biased in an advantageous, user selected amount by loosening the bolts that mount the depicted device to the stationary platen 12, moving the device as a whole and retightening the bolts. In the depicted embodiment, the mounting holes 56, 58 are slotted in a lateral, substantially horizontal direction, which provides a first direction in which adjustments may be made.

In the depicted embodiment the sprue bar position alignment frames 60 and 62 are attached to the mounting bracket. Each sprue bar position alignment frame has a channel 42 and 44 dimensioned to slidingly engage a sprue bar 90 in close cooperation.

As best seen in FIGS. 2 and 3, each sprue bar alignment frame may be comprised of either a fully circumscribing, four sided frame 60, or a partially circumscribing frame 62, which may be U-shaped as depicted. The fully circumscribing frame 60 includes a first, second, third and fourth face, 82, 84, 86 and 88 respectively, each of which may engage a sprue bar as a mold closes in a closely cooperating sliding engagement. As depicted, a partially circumscribing frame 62 may use an edge of another component, such as the bottom of the fully circumscribing frame 60, as its fourth engaging side.

As best seen in FIG. 3, mounting holes 64 and 66 in the frames 60 and 62 may also be slotted. Loosening the attaching bolts 68 allows an operator to move the frame to a new position that biases a sprue bar passing through the frame in a second direction. Removable fasteners also allow the frames to be reconfigured as needed to accommodate various sprue bar configurations.

Further adjustment may be provided by adjusting devices mounted on adjustment bars 100 and 110. These are fixedly attached to the mounting bracket and include a transverse through hole in which is fitted an adjusting screw 102 and 112. The adjusting screw may be threaded directly to the adjusting bar or made to smoothly engage the through hole and be threaded with a lock nut, 104 and 114 disposed as depicted, either between the adjusting bar and the frame 100, 60 or outside the adjusting bar 110. Against the fixed position of the adjusting bar 100 or 110, the adjustment screw may be used to bias the adjustment frame in a user selected amount in the preconfigured direction in which the adjustment screws are disposed, which is vertical in the depicted embodiment.

Also depicted in FIGS. 2, 3 and 4 are wear pads 120, which may be comprised of a material that is softer than the metal components otherwise acting in close cooperation, which includes the frames, mounting brackets and sprue bars. Hence, a small, inexpensive part, the wear pad, may be replaced when necessary, rather than allow wear to occur on the more expensive machined metal parts. The wear pads may be comprised of any bearing material, for example, a bronze alloy or a composite carbon fiber material. Each pad fits in a slot provided and is locked in place when the frame is bolted to the bracket. The wear pads are on the bottom of the frames depicted, as the weight of the sprue bars may be anticipated to cause wear there first in most cases.

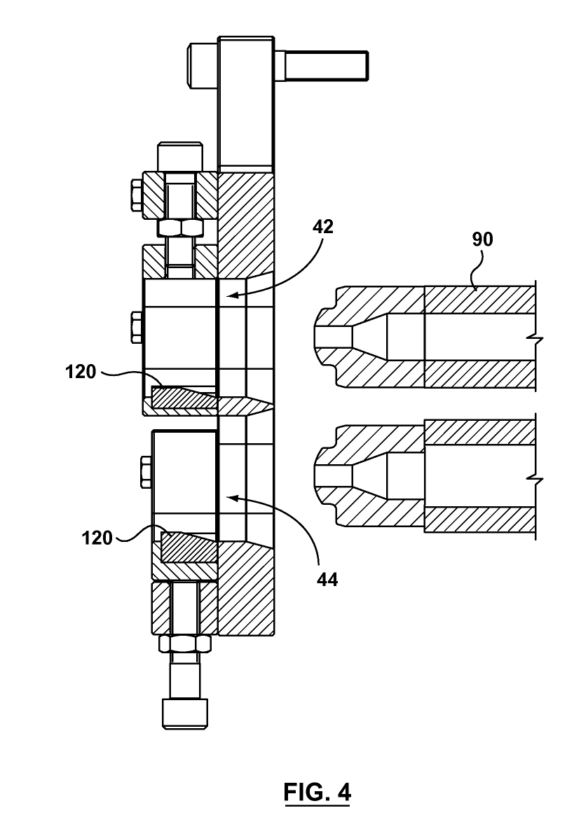

As best seen in cutaway side view FIG. 4, both the wear pads 120 and mold side apertures of the mounting bracket channels 42 and 44 are beveled to facilitate receipt of the advancing sprue bar. On the exit side of the sprue bar position alignment device, to the left in FIG. 4, the channel has a tighter tolerance in order to achieve the precise guidance of the sprue bars that is advantageous.

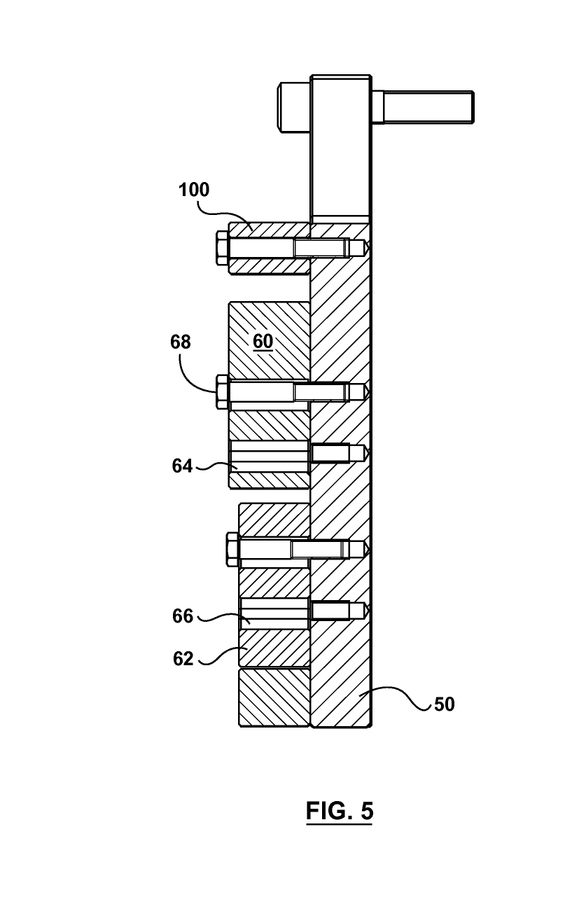

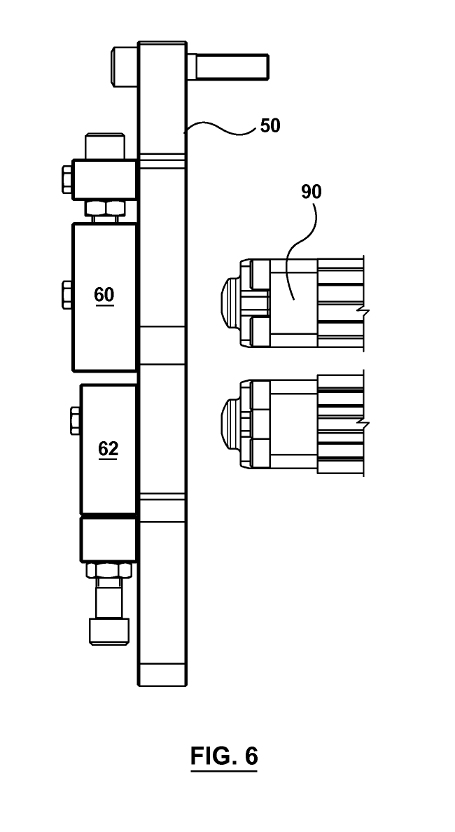

FIGS. 5 and 6 are side views of the sprue bar position alignment device showing mounting screws. In the depicted embodiment, top frame 60 extends farther in the direction of sprue bar travel than bottom frame 62. This prevents any possible molten plastic “drool” from top frame 60 from dripping onto bottom frame 62. As can be seen, the device may be configured to accommodate varying numbers of sprue bars by adding, removing or rearranging the frames on the mounting bracket.

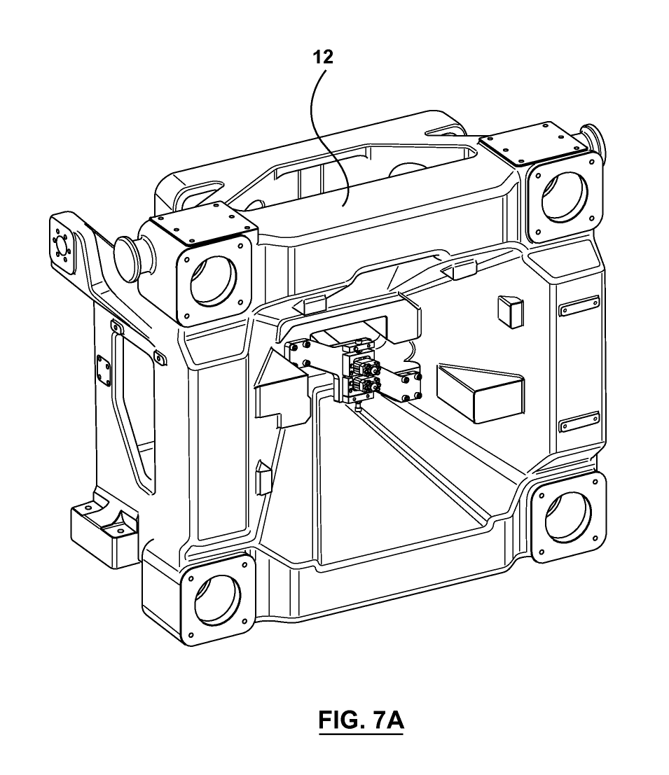

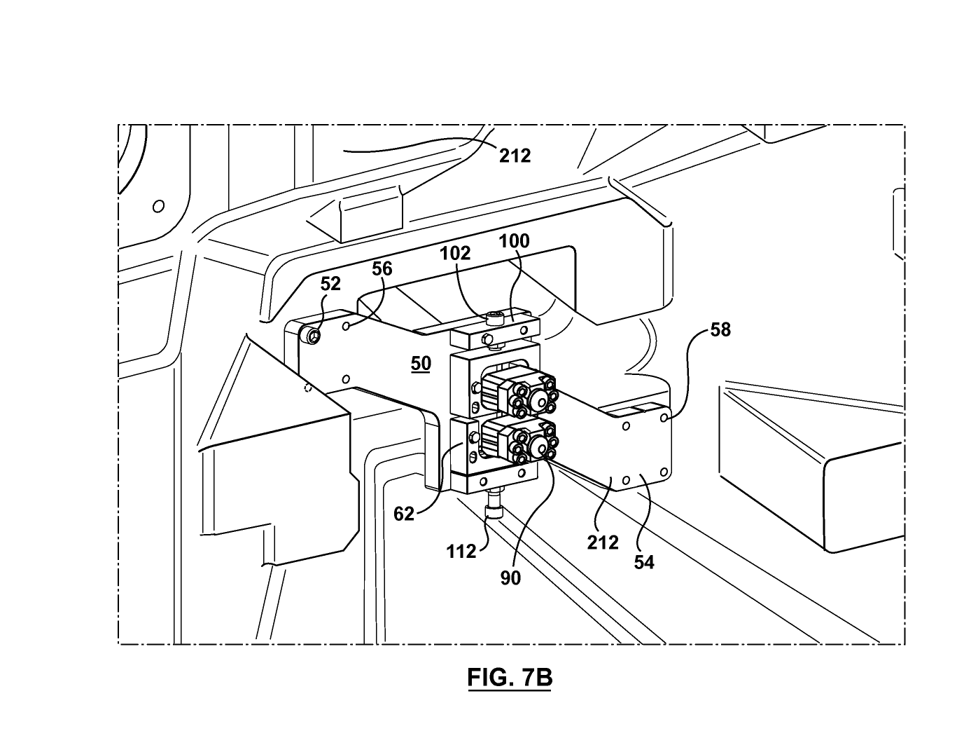

As can be seen in FIG. 7a, an isometric view of a stationary platen viewed from the side disposed towards the injection molding machine, and FIG. 7b, a close up thereof, the sprue bar position alignment device is external to the moving mold components. It is accessible by a workman from outside the overall mold assembly, without any disassembly of the overall mold assembly. As can be seen, the stationary platen 12 includes faces 212 which extend in a direction external to the moving mold components and towards the plastic injection machine. They provide a face onto which the mounting bracket extensions 52 and 54 may mate and be mounted, for example, through bolt holes 56 and 58. By so mounting the sprue bar position alignment device, the extension of the sprue bars 90 when the mold closes will bring them into engagement with the position alignment frames 60 and 62 whereupon their position may be maintained and, if necessary, guided or aligned, by the position alignment frames as the sprue bars advance towards the injection machine nozzles. If adjustment of the sprue bar position alignment frame is required, the adjustment screws 102 and 112 are readily accessible from outside the mold assembly.

In operation, a cycle begins with an open mold. The sprue bar ends 30 and 32 are disengaged from the sprue bar position alignment device. They may also be disengaged from the stationary platen, depending upon the mold configuration at hand. As the mold closes, the sprue bars advance through the stationary platen in channels provided for them. Next the sprue bars engage the sprue bar position alignment device where the sprue bar end bushings at each of ends 30 and 32 enter the apertures of channels 42 and 44 in the sprue bar position alignment device. The beveled apertures and wear pads urge each sprue bar towards its intended, pre-configured path and the channels 42 and 44 maintain the sprue bar there. In the depicted embodiment, it is the mounting bracket and not the frames that the sprue bars first engage, although a reverse configuration is equally within the scope of the present invention. As the mold closes, the sprue bars advance through the channels 42 and 44 in the position alignment device and are thereby guided and maintained in their proper alignment for advantageous mating and sealing with the injection machine nozzles. Advantageous position is maintained by the close, sliding cooperation of the sides of the sprue bar with at least the wear pads 120, and also as needed with the sides 82, 84 and 88 of channels 42 and 44. Upon full closure of the mold, the molten plastic is injected, the plastic parts form, and the mold then opens to release the parts. This cycle repeats.

Through a number of cycles of use, the paths of the sprue bars between the stationary platen and the injection machine nozzles may vary from the ideal. In the short term, this may occur through a change in the material being injected, through molten plastic drool or through other variables inherent in the manufacturing process. In the longer term, sprue bar paths may diverge from the ideal because of component wear over time. In either case, an operator may accommodate for these divergences and use the sprue bar position alignment device of the present invention to bias the sprue bars back towards their advantageous ideal path. This may be done in a first direction by loosening the sprue bar position alignment mounting bracket and moving the device as a whole. An adjustment in another direction may also be made by loosening a frame on the mounting bracket and moving it relative to the mounting bracket. This may be further achieved by rotating the adjustment screws. Adjustments may be combined. Adjustments may be kept in place by tightening bolts or lock screws. Adjustments may be made to accommodate the dimensions of replacement wear pads, which may change over time. All adjustments are externally accessible. That is, the sprue bar path may be adjusted without any disassembly of the mold.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An external sprue bar position alignment device comprising:
a mount, said mount having an alignment portion to receive a sprue bar and said alignment portion being disposed to maintain an end of the sprue bar in alignment with an injection nozzle during use.

2. The external sprue bar position alignment device of claim 1 wherein the alignment portion of the mount includes an adjustment device and a sprue bar position adjustment frame, said adjustment device providing movement of at least one of said mount or said sprue bar position alignment frame relative to a path of the sprue bar such that at least one of said mount or said sprue bar position alignment frame may bias the sprue bar in a selected direction upon the molding closing.

3. The external sprue bar position alignment device of claim 2 wherein said device is external to mold components between a first and a second mold platen.

4. The external sprue bar position alignment device of claim 2 wherein said device is mounted to a stationary platen.

5. The external sprue bar position alignment device of claim 4 wherein said device is mounted on an aspect of said stationary platen facing an injection machine.

6. The external sprue bar position alignment device of claim 2 wherein said mount is a mounting bracket.

7. The external sprue bar position alignment device of claim 2 wherein said mount is mounted with mounting bolts.

8. The external sprue bar position alignment device of claim 6 wherein said mounting bracket further comprises slotted through holes for mounting bolts.

9. The external sprue bar position alignment device of claim 2 wherein said adjustment device is an adjustment screw, said adjustment screw being disposed to bias said sprue bar position alignment frame in a first direction upon turning said screw in a first direction of rotation.

10. The external sprue bar position alignment device of claim 9 further comprising at least one other adjustment device, said adjusting device being configured to adjust said frame along said first direction and said at least one other adjustment device being configured to adjust said frame along a second direction.

11. The external sprue bar position alignment device of claim 9 wherein said adjustment device is selected from the group consisting of:
an adjustment screw, a slotted bolt hole through said sprue bar position alignment frame and a slotted bolt hole through said mounting bracket.

12. The external sprue bar position alignment device of claim 2 further comprising at least one other sprue bar position alignment frame, said at least one other frame being configured to position at least one other sprue bar.

13. The sprue bar position alignment device of claim 2 further comprising a wear pad, said wear pad being disposed within said channel.

14. The sprue bar position alignment device of claim 13 wherein said wear pad is a carbon fiber material.

15. An external sprue bar position alignment device comprising:
a mount;
a sprue bar position alignment frame, said frame being attached to said mount, said sprue bar position alignment frame and mount defining a channel configured to receive a sprue bar and said sprue bar position alignment frame and said mount being disposed to maintain an end of the sprue bar in alignment, during use, with an injection nozzle;
an adjustment device, said adjustment device providing movement of at least one of said mount or said sprue bar position alignment frame relative to a path of the sprue bar such that at least one of said mount or said sprue bar position alignment frame may bias the sprue bar in a selected direction upon the molding closing.

16. The external sprue bar position alignment device of claim 15 wherein said device is external to mold components between a first and a second mold platen.

17. The external sprue bar position alignment device of claim 15 wherein said device is mounted to a stationary platen.

18. The external sprue bar position alignment device of claim 17 wherein said device is mounted on an aspect of said stationary platen facing an injection machine.

19. The external sprue bar position alignment device of claim 15 wherein said mount is a mounting bracket.

20. The external sprue bar position alignment device of claim 15 wherein said mount is mounted with mounting bolts.

21. The external sprue bar position alignment device of claim 19 wherein said mounting bracket further comprises slotted through holes for mounting bolts.

22. The external sprue bar position alignment device of claim 13 wherein said adjustment device is an adjustment screw, said adjustment screw being disposed to bias said sprue bar position alignment frame in a first direction upon turning said screw in a first direction of rotation.

23. The external sprue bar position alignment device of claim 22 further comprising at least one other adjustment device, said adjusting device being configured to adjust said frame along said first direction and said at least one other adjustment device being configured to adjust said frame along a second direction.

24. The external sprue bar position alignment device of claim 22 wherein said adjustment device is selected from the group consisting of:
an adjustment screw, a slotted bolt hole through said sprue bar position alignment frame and a slotted bolt hole through said mounting bracket.

25. The external sprue bar position alignment device of claim 15 further comprising at least one other sprue bar position alignment frame, said at least one other frame being configured to position at least one other sprue bar.

26. The sprue bar position alignment device of claim 15 further comprising a wear pad, said wear pad being disposed within said channel.

27. The sprue bar position alignment device of claim 26 wherein said wear pad is a carbon fiber material.

28. An external sprue bar position alignment device comprising:
a mount;
a sprue bar position alignment frame, said frame being attached to said mount, said sprue bar position alignment frame and mount defining a plurality of channels configured to receive a plurality of sprue bars and said sprue bar position alignment frame and said mount being disposed to maintain ends of the plurality of sprue bars in alignment, during use, with an injection nozzle;
an adjustment device, said adjustment device providing movement of at least one of said mount or said sprue bar position alignment frame relative to a path of the sprue bar such that at least one of said mount or said sprue bar position alignment frame may bias the sprue bar in a selected direction upon the molding closing.

29. The external sprue bar position alignment device of claim 28 wherein said device is external to mold components.

30. The external sprue bar position alignment device of claim 28 wherein said device is mounted to a stationary platen.

31. The external sprue bar position alignment device of claim 30 wherein said device is mounted on an aspect of said stationary platen facing an injection machine.

32. The external sprue bar position alignment device of claim 28 wherein said mount is a mounting bracket.

33. The external sprue bar position alignment device of claim 28 wherein said mount is mounted with mounting bolts.

34. The external sprue bar position alignment device of claim 32 wherein said mounting bracket further comprises slotted through holes for mounting bolts.

35. The external sprue bar position alignment device of claim 28 wherein said adjustment device is an adjustment screw, said adjustment screw being disposed to bias said sprue bar alignment frame in a first direction upon turning said screw in a first direction of rotation.

36. The external sprue bar position alignment device of claim 35 further comprising at least one other adjustment device, said adjusting device being configured to adjust said frame along said first direction and said at least one other adjustment device being configured to adjust said frame along a second direction.

37. The external sprue bar position alignment device of claim 35 wherein said adjustment device is selected from the group consisting of:
an adjustment screw, a slotted bolt hole through said sprue bar position alignment frame and a slotted bolt hole through said mounting bracket.

38. The external sprue bar position alignment device of claim 28 further comprising a plurality of sprue bar position alignment frames, said plurality of sprue par position frames being configured to position a plurality of sprue bars.

39. The sprue bar position alignment device of claim 28 further comprising a plurality of wear pads, said plurality of wear pads being disposed within said plurality of channels.

40. The sprue bar position alignment device of claim 39 wherein said plurality of wear pads are from a carbon fiber material.

41. A sprue bar alignment apparatus, comprising:
an alignment device mounted externally to an injection mold for alignment of at least one sprue bar during use.

42. An injection molding stack comprising:
an injection molding stack having at least one platen;
a mount, said mount being attached to said platen on said injection molding stack;
a sprue bar position alignment frame, said frame being attached to said mount, said sprue bar position alignment frame and mount defining a channel configured to receive a sprue bar upon a mold closing and said sprue bar position alignment frame and said mount being disposed to maintain an end of the sprue bar in alignment with an injection nozzle;
an adjustment device, said adjustment device providing movement of at least one of said mount or said sprue bar position alignment frame relative to a path of the sprue bar such that at least one of said mount or said sprue bar position alignment frame may bias the sprue bar in a selected direction upon the molding closing.

43. An injection molding apparatus, comprising:
an injection molding machine, the machine having an injection unit;
an injection mold for use with the injection molding machine;
at least one sprue bar extending inside and outside a boundary of the mold; and
an alignment device located external to the boundary of the mold for aligning the at least one sprue bar during use.
